(19) United States
(12) Patent Application Publication
(10) Pub. No.: US 2021/0357753 A1
(43) Pub. Date: Nov. 18, 2021

(54) METHOD AND APPARATUS FOR MULTI-LEVEL STEPWISE QUANTIZATION FOR NEURAL NETWORK

(71) Applicant: ELECTRONICS AND TELECOMMUNICATIONS RESEARCH INSTITUTE, Daejeon (KR)

(72) Inventors: Jin Kyu KIM, Incheon (KR); Byung Jo KIM, Sejong-si (KR); Seong Min KIM, Sejong-si (KR); Ju-Yeob KIM, Daejeon (KR); Ki Hyuk PARK, Daejeon (KR); Mi Young LEE, Daejeon (KR); Joo Hyun LEE, Daejeon (KR); Young-deuk JEON, Sejong-si (KR); Min-Hyung CHO, Daejeon (KR)

(73) Assignee: ELECTRONICS AND TELECOMMUNICATIONS RESEARCH INSTITUTE, Daejeon (KR)

(21) Appl. No.: 17/317,607

(22) Filed: May 11, 2021

(30) Foreign Application Priority Data
May 12, 2020 (KR) 10-2020-0056641

(51) Int. Cl. G06N 3/08; G06N 3/04

(52) U.S. Cl. CPC G06N 3/08; G06N 3/04

(57) ABSTRACT

A method and apparatus for multi-level stepwise quantization for neural network are provided. The apparatus sets a reference level by selecting a value from among values of parameters of the neural network in a direction from a high value equal to or greater than a predetermined value to a lower value, and performs learning based on the reference level. The setting of a reference level and the performing of learning are iteratively performed until the result of the reference level learning satisfies a predetermined value and there is no variable parameter that is updated during learning among the parameters.

### CROSS-REFERENCE TO RELATED APPLICATION

This application claims priority to and the benefit of Korean Patent Application No. 10-2020-0056641 filed in the Korean Intellectual Property Office on May 12, 2020, the entire contents of which are incorporated herein by reference.

### BACKGROUND OF THE INVENTION

### (a) Field of the Invention

The present disclosure relates to a neural network, and more particularly, the present disclosure relates to a method and apparatus for multi-level stepwise quantization for a neural network.

### (b) Description of the Related Art

As research on neural networks using deep-learning is actively progressing, various types of neural networks with cognitive detection performance similar to human judgment have been continuously published. Since these neural networks aim for recognition performance rather than the entire computational amount, very large parameters ranging from as few as tens of megabytes to as many as hundreds of megabytes are required. Because recognition processing is performed for each image input from a camera, large-scale parameters must be used repeatedly for each frame. Therefore, there is a drawback that is very difficult to operate unless a system equipped with a graphics processing unit (GPU) server with high hardware operation performance or a dedicated hardware accelerator, etc. is installed.

There is a trade-off between high detection accuracy and hardware computational complexity. Therefore, in recent years, algorithms that can appropriately allocate and determine hardware resources necessary to process various applications according to an appropriate target recognition detection rate are being released. For example, MobileNet versions 1/2/3, which drastically reduce the amount of entire operation while not having large performance attenuation suitable for mobile applications, has been announced one after another. In addition, NASNET and MNASNET, which help to create a desired neural network by changing the layer structure and kernel size in various ways and proceeding with learning so that the hyper parameters in the neural network can be appropriately determined, are being announced. In addition, although the neural network's complexity is large, DenseNet and PeleeNet, which have significantly reduced the number of required parameters, have also been announced.

In face recognition and object recognition using a deep learning neural network, in order to achieve high object detection accuracy, it is inevitable to have a large number of layers as the neural network structure becomes complex. As the number of layers increases, it means that a parameter of large capacity is required to process a single image. Therefore, a neural network compression method is required to reduce the size of a parameter of large capacity.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present disclosure has been made in an effort to provide a method and an apparatus for quantization to reduce a size of a parameter in a neural network.

In addition, the present disclosure has been made in an effort to provide a method and an apparatus for optimizing a size of a parameter through a multi-level stepwise quantization process.

According to an embodiment of the present disclosure, a quantization method in a neural network is provided. The quantization method includes: setting a reference level by selecting a value from among values of parameters of the neural network in a direction from a high value equal to or greater than a predetermined value to a lower value; and performing reference level learning while the set reference level is fixed, wherein the setting of a reference level and the performing of reference level learning are iteratively performed until the result of the reference level learning satisfies a predetermined value and there is no variable parameter that is updated during learning among the parameters.

In an implementation, the quantization method may include, when the result of the reference level learning does not satisfy the predetermined value, adding an offset level for the reference level and then performing offset level learning in which learning is performed while the offset level is fixed.

In an implementation, the setting of a reference level, the performing of reference level learning, and the performing of offset level learning may be iteratively performed until the result of the reference level learning or the result of the offset level learning satisfies a predetermined value and there is no variable parameter that is updated during learning among the parameters.

In an implementation, the being fixed may represent that no update to a parameter is performed during learning.

In an implementation, the being fixed may include that parameters included in a setting range around the reference level or the offset level are fixed, and parameters not included in the setting range may be variable parameters that are updated during learning.

In an implementation, in the performing of offset level learning, the offset level may be a level corresponding to a lowest value among parameters included in a set range around the reference level.

In an implementation, the addition of the offset level may be performed in a direction in which a scale is increased by a set multiple starting from a level corresponding to the lowest value.

In an implementation, the quantization method may include, when the result of the reference level learning or the result of the offset level learning satisfies the predetermined value and there is no variable parameter that is updated during learning among the parameters, determining a quantization bit based on the reference level set so far and the offset level added so far.

In an implementation, the determining of a quantization bit may include: determining a quantization bit of parameters corresponding to the reference levels set so far according to a number of reference levels set so far; and determining a quantization bit of parameters corresponding to the offset levels added so far according to a number of offset levels added so far.

In an implementation, the quantization method may include, before the determining of a quantization bit, setting remaining parameters to 0 except for parameters corresponding to the reference levels set so far and parameters corresponding to the offset levels added so far.

In an implementation, the setting of a reference level may include setting a maximum value among values of the parameters as a reference level, and then setting a random value in a direction from the maximum value to a minimum value.

According to another embodiment of the present disclosure, a quantization apparatus in a neural network is provided. The quantization apparatus includes: an input interface device; and a processor configured to perform multi-level stepwise quantization for the neural network based on data input through the interface device, wherein the processor is configured to set a reference level by selecting a value from among values of parameters of the neural network in a direction from a high value equal to or greater than a predetermined value to a lower value, and perform learning based on the reference level, wherein the setting of a reference level and the performing of learning are iteratively performed until the result of the reference level learning satisfies a predetermined value and there is no variable parameter that is updated during learning among the parameters.

In an implementation, the processor may be configured to perform the following operations: setting a reference level by selecting a value from among values of parameters of the neural network; performing reference level learning while the set reference level is fixed; and when the result of the reference level learning does not satisfy the predetermined value, adding an offset level for the reference level and then performing offset level learning in which learning is performed while the offset level is fixed, and wherein the setting of a reference level, the performing of reference level learning, and the performing of offset level learning may be iteratively performed until the result of the reference level learning or the result of the offset level learning satisfies a predetermined value and there is no variable parameter that is updated during learning among the parameters.

In an implementation, the being fixed may represent that no update to a parameter is performed during learning.

In an implementation, the being fixed may include that parameters included in a setting range around the reference level or the offset level are fixed, and parameters not included in the setting range are variable parameters that are updated during learning.

In an implementation, in the performing of offset level learning, the offset level may be a level corresponding to a lowest value among parameters included in a set range around the reference level.

In an implementation, the addition of the offset level may be performed in a direction in which a scale is increased by a set multiple starting from a level corresponding to the lowest value.

In an implementation, the processor may be further configured to perform the following operation: when the result of the reference level learning or the result of the offset level learning satisfies the predetermined value and there is no variable parameter that is updated during learning among the parameters, determining a quantization bit based on the reference level set so far and the offset level added so far.

In an implementation, when performing the determining of a quantization bit, the processor may be specifically configured to perform the following operation: determining a quantization bit of parameters corresponding to the reference levels set so far according to a number of reference levels set so far; and determining a quantization bit of parameters corresponding to the offset levels added so far according to a number of offset levels added so far.

In an implementation, before the determining of a quantization bit, the processor may be further configured to perform the following operation: setting remaining parameters to 0 except for parameters corresponding to the reference levels set so far and parameters corresponding to the offset levels added so far.

### BRIEF DESCRIPTION OF THE DRAWINGS

FIG. 1 is a diagram illustrating the structure of a neural network that performs an image object recognition operation.

FIG. 2 is a diagram illustrating a parameter compression method in a general neural network.

FIG. 3 is a diagram illustrating a multi-level stepwise quantization method according to an embodiment of the present disclosure.

FIG. 4 is an exemplary diagram illustrating a result of a multi-level stepwise quantization method according to an embodiment of the present disclosure.

FIG. 5 is a flowchart of a multi-level stepwise quantization method according to an embodiment of the present disclosure.

FIG. 6 is a diagram showing the structure of a quantization apparatus according to an embodiment of the present disclosure.

### DETAILED DESCRIPTION OF THE EMBODIMENTS

In the following detailed description, only certain embodiments of the present disclosure have been shown and described, simply by way of illustration. Hereinafter, embodiments of the present disclosure will be described in detail with reference to the accompanying drawings so that those of ordinary skill in the art may easily implement the present disclosure. As those skilled in the art would realize, the described embodiments may be modified in various different ways, all without departing from the spirit or scope of the present disclosure. However, the present disclosure may be implemented in various different forms and is not limited to the embodiments described herein. Accordingly, the drawings and description are to be regarded as illustrative in nature and not restrictive. Like reference numerals designate like elements throughout the specification. In the drawings, parts irrelevant to the description are omitted in order to clearly describe the present disclosure, and similar reference numerals are attached to similar parts throughout the specification.

Throughout the specification, in addition, unless explicitly described to the contrary, the word “comprise”, and variations such as “comprises” or “comprising”, will be understood to imply the inclusion of stated elements but not the exclusion of any other elements.

The expressions described in the singular may be interpreted as singular or plural unless an explicit expression such as “one”, “single”, and the like is used.

In addition, terms including ordinal numbers such as “first” and “second” used in embodiments of the present disclosure may be used to describe components, but the components should not be limited by the terms. The terms are only used to distinguish one component from another. For example, without departing from the scope of the present disclosure, a first component may be referred to as a second component, and similarly, the second component may be referred to as the first component.

Hereinafter, a method and an apparatus for multi-level stepwise quantization in a neural network according to an embodiment of the present disclosure will be described with reference to the drawings.

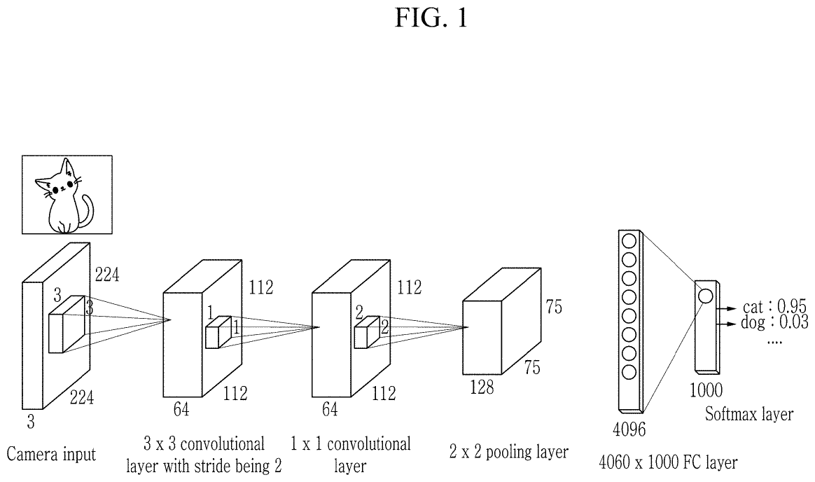

FIG. 1 is a diagram illustrating the structure of a neural network that performs an image object recognition operation.

In FIG. 1, the neural network is a convolutional neural network (CNN), and includes a convolutional layer, a pooling layer, a fully connected (FC) layer, a softmax layer, and the like. When the image data of a video or photo is input from a camera to the CNN, results such as the type of the object (for example, the type of the object is a cat) or the location of the object are output through the CNN.

Most of the operations in the CNN are convolutional operations, and require parameters such as a weight called a kernel and a bias.

When designing such a neural network structure, learning is performed using an operation based on a 32-bit single-precision floating point, and the goal is to optimize the structure of the neural network for high detection accuracy. In the hardware object recognition operation using the completed neural network structure, data in a 16-bit half-precision floating point data format or data in an 8-bit fixed point format are mainly used. In order to further reduce the size of the entire parameter, a minimal quantization process is used using expressions such as ternary using only {−1, 0.1} and binary using only {−1, 1} in performing learning.

However, if information of a parameter is expressed in a smaller bit size, the overall size can be reduced, but there is a disadvantage in that detection accuracy is lowered accordingly. Therefore, depending on the implementation, ternary and binary are used only for some layers, and a combination of half-precision floating-point and fixed-point operations are also used.

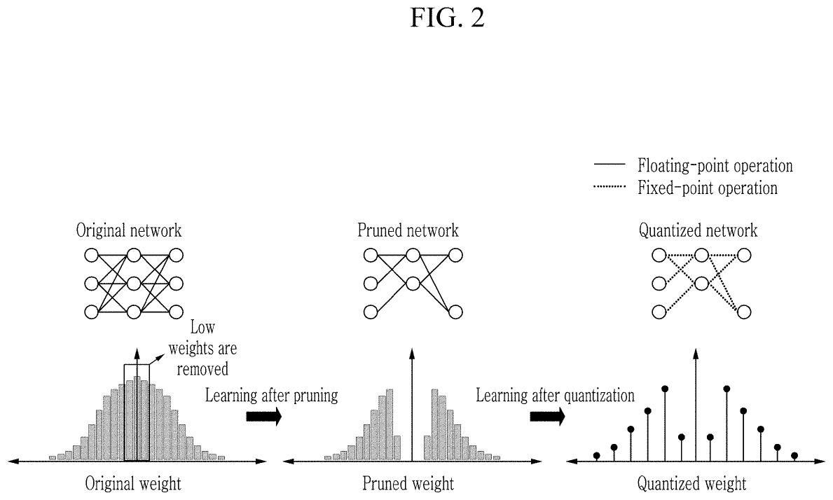

FIG. 2 is a diagram illustrating a parameter compression method in a general neural network.

In general, for parameter compression, a quantization process proceeds through two steps.

The first step is a pruning learning step that removes low weights. This is a method of reducing the total number of multiply accumulate (MAC) operations by approximating a connection with a low weight value to ‘0’. In this case, an appropriate threshold is required, which is determined according to the distribution of weights used in the corresponding layer.

Learning starts from the value multiplied by a constant depending on the value of the standard deviation. By increasing a threshold under the condition that the recognition detection accuracy is not attenuated, the learning is performed in the direction of increasing the pruning effect in each layer. The pruning learning performed for each layer may be performed from the first layer or may be performed from the last layer. When the final threshold value for each layer is determined in the entire neural network through this process, weights converted to zero and non-zero weights may be classified. In the case of ‘0’, since a MAC operation is not required, the MAC operation is performed only for non-zero weights.

The second step is a step that performs quantization on non-zero weights. As described above, a general quantization method is to perform learning by converting a 32-bit floating point representation into a 16-bit or 8-bit floating point or fixed point form, or converting it into a form such as ternary/binary.

In the prior art, it is possible to obtain a parameter result usable in hardware only through the two steps described above. Also, since the interval between data used in the quantization process is equally divided, an optimized quantization result according to the distribution may not be output.

In recent years, the proposed neural network undergoes an optimization process of connection between nodes from the structure design stage, and thus performance cannot be secured by the conventional pruning method. This also means that the effect obtained by the existing pruning method is decreasing.

An embodiment of the present disclosure provides a stepwise quantization method based on a level reference value. Here, the method of learning so that the neural network parameters exist in the form of a normal distribution centered on the reference values of several levels is preceded. For this, the learning is carried out by stepwise fixing from the high reference value. The parameter of the neural network may be a value that determines the intensity of reflection of the data input to the layer when the data input to each layer is transferred to the next layer in the neural network, and may include weight, bias, etc. Here, the parameter excludes parameters of other layers generated in the learning process. For example, in the inference operation that performs only object recognition after learning, the batch normalizer layer's parameters are absorbed and implemented by the weight and bias parameters used in the convolutional layer, and then parameters such as mean, variance, scale, and shift used in the batch normalizer layer are excluded.

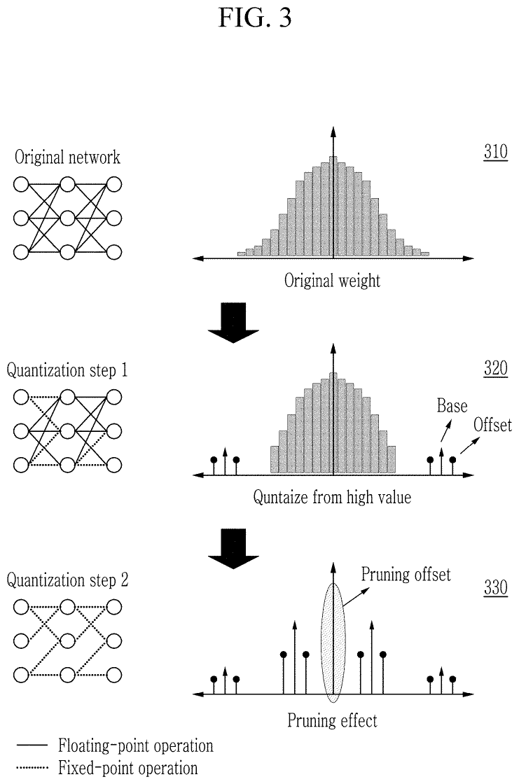

FIG. 3 is a diagram illustrating a multi-level stepwise quantization method according to an embodiment of the present disclosure.

In an embodiment of the present disclosure, in order to significantly reduce the overall size of parameters required in a neural network through a hierarchical quantization process, quantization is performed sequentially from a high quantization level to a low quantization level according to a distribution of weights. Because it uses a hierarchical method, it is accompanied by quantization learning. The quantization process proceeds by obtaining a value that becomes a reference point and an offset value according to the reference point.

Specifically, in the original network, it is possible to see a connection and a probability distribution function of weights that have been trained using a floating-point parameter (310 in FIG. 30).

In this state, quantization step 1 is performed (320 in FIG. 3). To this end, a base reference level of a higher level is created based on the largest value among weights. The base reference level is set based on the largest value among the weights, and only the corresponding base reference level is made to exist, and after fixing it, learning proceeds. That is, weights within a certain range centered on the base reference level are fixed and learning is performed. Here, the fixing means that the weights are not updated through learning.

After learning, if the detection accuracy is not output as much as the reference value, that is, the baseline, offset levels are added one by one. As for the offset level, several levels can be added according to necessity. In this process, if the detection accuracy is comparable to that of the baseline, no offset level is added.

If the base reference level and the offset level of the largest values are fixed, the quantization step 2 is performed (330 in FIG. 3). To do this, a base reference level of a lower level is created. For example, a base reference level of a lower level is set based on the largest value among weights that are not fixed. Only the base reference level is made to exist, and then the base reference level is fixed and learning is performed. Even in this case, if the detection accuracy is not output as much as the baseline after learning, offset levels are added one by one. As for the offset level, several levels can be added according to necessity, and if the detection accuracy is output as much as the baseline, the level addition is not performed.

If the above-described process is repeatedly performed, several base reference levels may be created, and several offset levels according to each base reference level may be generated.

The results obtained through the multi-level stepwise quantization method according to an embodiment of the present disclosure are as follows.

First, learning is performed using a certain amount of offset values based on a base reference label, that is, a coarse value. This means that quantization is not performed for each group, but quantization is performed from a high-level value to a low-level value. Also, depending on the learning, the offset level may not be necessary. For example, when the interval of the base reference levels maintains a proportional distance equal to twice as much and no offset level is required, multiplication in MAC operations of all weights may be performed in the form of a shifter without a multiplier. In addition, when only one base reference level exists and no offset level is required, a result similar to the operation of a ternary neural network can be obtained.

Second, if learning of variable weights becomes meaningless before reaching the base reference level of the lower level, the effect of pruning can also be seen. This means that the two-step operation of performing pruning and quantizing in the conventional method is processed into a single operation. The difference is that if the conventional method is a method of approximating as many weights as possible to 0 and maintaining the original detection accuracy by using the remaining active weights, the method according to an embodiment of the present disclosure is considered a weak pruning method. However, lower weights have the advantage that they can be expressed with a smaller bit width in an embodiment of the present disclosure.

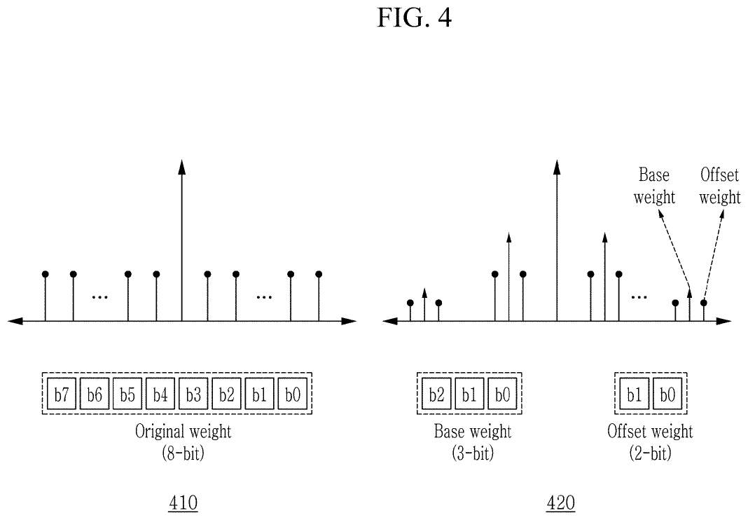

FIG. 4 is a diagram illustrating a result of a multi-level stepwise quantization method according to an embodiment of the present disclosure.

In FIG. 4, 410 denotes 8-bit weights obtained through uniform quantization. If the distribution of weights has a uniform distribution between the minimum and maximum values, the uniform quantization method will be the most optimized method. However, as previously described, the probability distribution of weights generally has the same form as the normal distribution.

When performing multi-level stepwise quantization according to an embodiment of the present disclosure, a result similar to 420 in FIG. 4 is obtained. If the base reference level (a base weight) includes ‘0’, there are 5 base reference levels, and there are 3 offset levels including the base reference level ‘0’. Thus, the base weights can be quantized into 3 bits and the offset weights can be quantized into 2 bits. If encoding is performed only when the weight is non-zero, the total of the base reference levels are 4 levels and the total of the offset levels are 2 levels, and accordingly, the weights corresponding to the base reference levels can be quantized into 2 bits and the weights corresponding to the offset levels can be quantized into 1 bit.

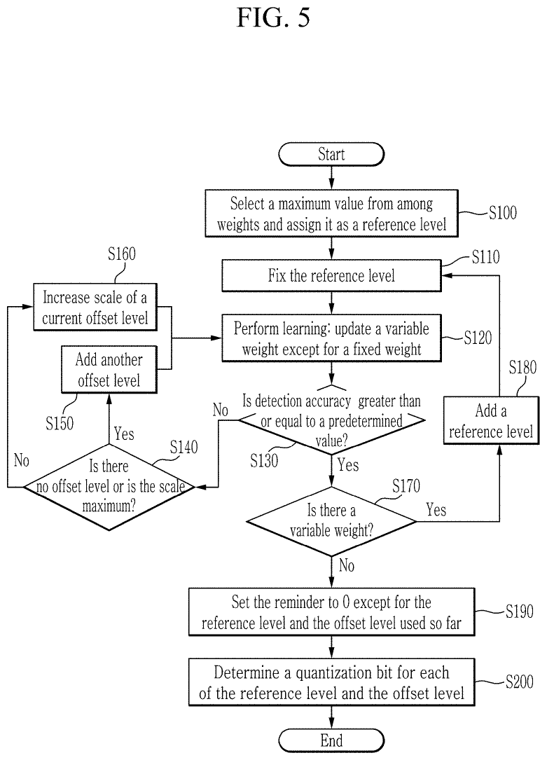

FIG. 5 is a flowchart of a multi-level stepwise quantization method according to an embodiment of the present disclosure.

The quantization method according to an embodiment of the present disclosure may be simultaneously applied to all layers in a neural network, or may be performed for each layer, starting from a layer at a front or a layer at a later stage, even if a long learning time is required.

First, it is assumed that the method of learning that the parameters of the neural network exist in the form of a normal distribution centered on the reference values of various levels is preceded, and that, for example, a connection and a probability distribution function of weights which are parameters such as 310 in FIG. 3 are obtained.

As shown in FIG. 5, a maximum value is selected from among parameters, that is, weights, of a layer of a neural network, and the selected maximum value is assigned as a base reference level (S100). Then, the base reference level is fixed (S110). The fixing means that the updating of a weight value is not performed in learning.

In addition, since not only is the corresponding value fixed, but all values within a certain range centered on the base reference level must be the base reference level, and all weight values within a certain range, that is, within the setting region, are fixed. Therefore, the weights in the setting region are fixed and not updated during learning, and the remaining weights not included in the setting region are variable weights and can be continuously updated during learning. This setting region can be given as another parameter in learning.

After fixing the base reference level, learning is performed (S120), and the detection accuracy according to the learning result is calculated and compared with a predetermined value (a reference value) (S130). To obtain the detection accuracy according to the learning result, a known technique can be used, so a detailed description thereof will be omitted.

When the detection accuracy according to the learning result is not greater than or equal to the predetermined value, that is, when the desired detection accuracy is not output, learning is additionally performed by adding an offset level. One from among weight values included in the setting region centered on the base reference level is added as an offset level. For convenience of explanation, the setting region centered on the base reference level may be referred to as a fixed level weight region.

An offset level is added based on weight values included in the fixed level weight region. The offset level addition is performed in a direction in which the scale is increased by a set multiple (e.g., a multiple of 2) starting from a level corresponding to the lowest weight value in the fixed level weight region. That is, if the desired detection accuracy is not obtained even after learning by adding an offset level corresponding to the lowest weight value in the fixed level weight region, a value corresponding to twice the lowest weight value is added as an offset level and then learning is performed. In this way, the addition of an offset level and learning accordingly are performed. Here, the reason for increasing the scale by a multiple of 2 is to enable expression using 1 bit no matter what value the actual distance from the base reference level is.

If the desired detection accuracy does not come out even when the scale reaches the maximum value in the setting region of the base reference level, an offset reference level must be added.

Specifically, in step of S130, if the detection accuracy according to the learning result is not greater than or equal to the predetermined value, offset level addition is performed. To this end, if there is no offset level for the current base reference level, an offset level is added (S140, S150), and when the scale of the corresponding offset level is maximum in the state that there is a current offset level (when the scale of the current offset level is the maximum value of the corresponding fixed level weight region), another offset level is added (S140 and S150). On the other hand, when there is a current offset level and the scale of the corresponding offset level is not the maximum, the scale of the current offset level is increased by a multiple of 2 (S160).

In this way, after adding an offset level or increasing the scale of the offset level, learning is performed using the corresponding offset level. That is, the weights within a certain range, that is, within the setting region around the offset level, are fixed and not updated during learning, and the remaining weights not included in the setting region are variable weights and can be continuously updated during learning. After adding the offset level, the detection accuracy according to the result of learning is compared with the predetermined value.

When learning at the base reference level or learning after adding an offset level is performed, and in step S130, if the detection accuracy is greater than or equal to the predetermined value, the reference level addition is determined according to whether or not there is a variable weight (S170).

Even if the desired detection accuracy is obtained as a result of the learning, if there are variable weights that are not included in the setting region centered on the base reference level or the offset level, the reference level is added (S180). For example, the highest value among variable weights may be set as an additional reference level. In addition to the base reference level set in step of S100, a reference level different from the base reference level is added, the added reference level is fixed, and learning is performed again. Therefore, learning is performed while the weights in the setting region centered on the added reference level in addition to the base reference level are fixed. The above steps (S110 to S170) are repeatedly performed for the added reference level. Accordingly, the number of reference levels including the base reference level and the number of offset levels according to each reference level are obtained.

In step of S180, if the detection accuracy is greater than or equal to the above predetermined value and then the desired detection accuracy comes out, and the variable weight does not exist, the weights other than the reference level(s) and the offset level(s) used for learning are set to 0 (S190).

Next, quantization bits are determined for each of the reference level and the offset level obtained (or used) according to the learning (S200). That is, quantization bits for the base weights are determined according to the number of reference levels (including the base reference level) used according to learning, and quantization bits for the offset weights according to the number of offset levels used according to learning are determined. Then, the quantization bit width may be determined according to the number of each level.

According to the embodiment of the present disclosure, quantization for weights is performed from a high level value to a low level value rather than performing quantization for each group.

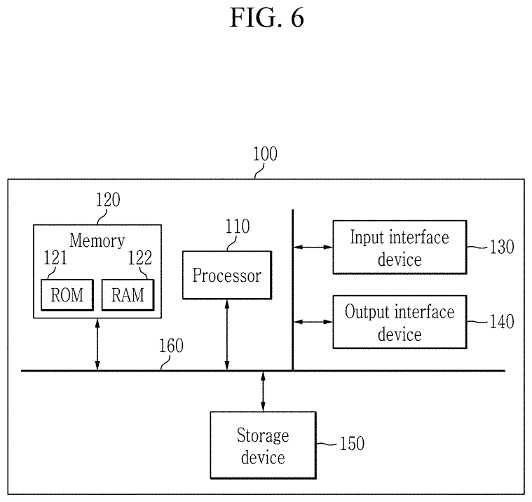

FIG. 6 is a diagram illustrating the structure of a quantization apparatus according to an embodiment of the present disclosure.

The quantization apparatus according to an embodiment of the present disclosure may be implemented as a computer system, as shown in FIG. 6.

The quantization apparatus 100 includes a processor 110, a memory 120, an input interface device 130, an output interface device 140, and a storage device 150. Each of the components may be connected by a bus 160 to communicate with each other. In addition, each of the components may be connected through an individual interface or an individual bus centered on the processor 110 instead of the common bus 160.

The processor 110 may execute a program command stored in at least one of the memory 120 and the storage device 150. The processor 110 may mean a central processing unit (CPU) or a dedicated processor for performing the forgoing methods according to embodiments of the present disclosure. The processor 110 may be configured to implement a corresponding function in the method described based on FIGS. 3 to 5 above.

The memory 120 is connected to the processor 110 and stores various information related to the operation of the processor 110. The memory 120 stores instructions for an action to be performed by the processor 110, or may temporarily store an instruction loaded from the storage device 150.

The processor 110 may execute instructions that are stored or loaded into the memory 120. The memory 120 may include a ROM 121 and a RAM 122.

In an embodiment of the present disclosure, the memory 120 and the storage device 150 may be located inside or outside the processor 110, and the memory 120 and the storage device 150 may be connected to the processor 110 through various known means.

According to an embodiment of the present disclosure, the size of a parameter may be optimized through a multi-level stepwise quantization process. In addition, while two steps of pruning and quantization are performed in the prior art, only quantization is performed according to an embodiment of the present disclosure to optimize parameters.

In addition, by performing quantization from a high level to a low level, quantization learning may be performed by prioritizing a value having a large weight. In addition, by applying the value of the reference quantization level as a multiple of 2, it is possible to have an effect of replacing a multiplier operation with a shift operation even during a convolution operation in a neural network.

Further, since quantization can be performed separately by dividing into a reference level weight and an offset level weight, the bit scale of the entire parameter can be reduced.

The embodiments of the present disclosure are not implemented only through the apparatus and/or method described above, but may be implemented through a program for realizing a function corresponding to the configuration of the embodiment of the present disclosure, and a recording medium in which the program is recorded. This implementation can also be easily performed by expert person skilled in the technical field to which the present disclosure belongs from the description of the above-described embodiments.

The components described in the embodiment s may be implemented by hardware components including, for example, at least one digital signal processor (DSP), a processor, a controller, an application-specific integrated circuit (ASIC), a programmable logic element such as an FPGA, other electronic devices, or combinations thereof. At least some of the functions or the processes described in the embodiment s may be implemented by software, and the software may be recorded on a recording medium. The components, functions, and processes described in the embodiment s may be implemented by a combination of hardware and software.

The method according to embodiment s may be embodied as a program that is executable by a computer, and may be implemented as various recording media such as a magnetic storage medium, an optical reading medium, and a digital storage medium. Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages, and may be deployed in any form including a stand-alone program or a module, a component, a subroutine, or other units appropriate for use in a computing environment. A computer program may be deployed to be executed on one computer or on multiple computers at one site or distributed across multiple sites and interconnected by a communication network. Processors appropriate for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic disks, magneto-optical disks, or optical disks. Examples of information carriers appropriate for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., and magneto-optical media such as a floptical disk, and a read only memory (ROM), a random access memory (RAM), a flash memory, an erasable programmable ROM (EPROM), and an electrically erasable programmable ROM (EEPROM), and any other known computer readable medium. A processor and a memory may be supplemented by, or integrated with, a special purpose logic circuit. The processor may run an operating system (OS) and one or more software applications that run on the OS. The processor device also may access, store, manipulate, process, and create data in response to execution of the software. For the purpose of simplicity, the description of a processor device is used as singular; however, one skilled in the art will appreciate that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media. The present specification includes details of a number of specific implementations, but it should be understood that the details do not limit any disclosure or what is claimable in the specification but rather describe features of the specific embodiment. Features described in the specification in the context of individual embodiment s may be implemented as a combination in a single embodiment. In contrast, various features described in the specification in the context of a single embodiment may be implemented in multiple embodiment s individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination. Similarly, even though operations are described in a specific order in the drawings, it should not be understood that the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described embodiment s in all embodiment s, and it should be understood that the above-described program components and apparatuses may be incorporated into a single software product or may be packaged in multiple software products. It should be understood that the embodiment s disclosed herein are merely illustrative and are not intended to limit the scope of the disclosure. It will be apparent to one of ordinary skill in the art that various modifications of the embodiment s may be made without departing from the spirit and scope of the claims and their equivalents.

What is claimed is:

1. A quantization method in a neural network, comprising:
setting a reference level by selecting a value from among values of parameters of the neural network in a direction from a high value equal to or greater than a predetermined value to a lower value; and
performing reference level learning while the set reference level is fixed,
wherein the setting of a reference level and the performing of reference level learning are iteratively performed until the result of the reference level learning satisfies a predetermined value and there is no variable parameter that is updated during learning among the parameters.

2. The quantization method of claim 1, further comprising:
when the result of the reference level learning does not satisfy the predetermined value, adding an offset level for the reference level and then performing offset level learning in which learning is performed while the offset level is fixed.

3. The quantization method of claim 2, wherein
the setting of a reference level, the performing of reference level learning, and the performing of offset level learning are iteratively performed until the result of the reference level learning or the result of the offset level learning satisfies a predetermined value and there is no variable parameter that is updated during learning among the parameters.

4. The quantization method of claim 2, wherein
the being fixed represents that no update to a parameter is performed during learning.

5. The quantization method of claim 4, wherein
the being fixed includes that parameters included in a setting range around the reference level or the offset level are fixed, and parameters not included in the setting range are variable parameters that are updated during learning.

6. The quantization method of claim 2, wherein
in the performing of offset level learning,
the offset level is a level corresponding to a lowest value among parameters included in a set range around the reference level.

7. The quantization method of claim 6, wherein
the addition of the offset level is performed in a direction in which a scale is increased by a set multiple starting from a level corresponding to the lowest value.

8. The quantization method of claim 2, further comprising:
when the result of the reference level learning or the result of the offset level learning satisfies the predetermined value and there is no variable parameter that is updated during learning among the parameters, determining a quantization bit based on the reference level set so far and the offset level added so far.

9. The quantization method of claim 8, wherein
the determining of a quantization bit comprises:
determining a quantization bit of parameters corresponding to the reference levels set so far according to a number of reference levels set so far; and
determining a quantization bit of parameters corresponding to the offset levels added so far according to a number of offset levels added so far.

10. The quantization method of claim 8, further comprising:
before the determining of a quantization bit,
setting remaining parameters to 0 except for parameters corresponding to the reference levels set so far and parameters corresponding to the offset levels added so far.

11. The quantization method of claim 1, wherein
the setting of a reference level comprises setting a maximum value among values of the parameters as a reference level, and then setting a random value in a direction from the maximum value to a minimum value.

12. A quantization apparatus in a neural network, comprising:
an input interface device; and
a processor configured to perform multi-level stepwise quantization for the neural network based on data input through the interface device,
wherein the processor is configured to set a reference level by selecting a value from among values of parameters of the neural network in a direction from a high value equal to or greater than a predetermined value to a lower value, and perform learning based on the reference level,
wherein the setting of a reference level and the performing of learning are iteratively performed until the result of the reference level learning satisfies a predetermined value and there is no variable parameter that is updated during learning among the parameters.

13. The quantization apparatus of claim 12, wherein
the processor is configured to perform the following operations:
setting a reference level by selecting a value from among values of parameters of the neural network;
performing reference level learning while the set reference level is fixed; and
when the result of the reference level learning does not satisfy the predetermined value, adding an offset level for the reference level and then performing offset level learning in which learning is performed while the offset level is fixed, and
wherein the setting of a reference level, the performing of reference level learning, and the performing of offset level learning are iteratively performed until the result of the reference level learning or the result of the offset level learning satisfies a predetermined value and there is no variable parameter that is updated during learning among the parameters.

14. The quantization apparatus of claim 13, wherein
the being fixed represents that no update to a parameter is performed during learning.

15. The quantization apparatus of claim 14, wherein
the being fixed includes that parameters included in a setting range around the reference level or the offset level are fixed, and parameters not included in the setting range are variable parameters that are updated during learning.

16. The quantization apparatus of claim 13, wherein
in the performing of offset level learning, the offset level is a level corresponding to a lowest value among parameters included in a set range around the reference level.

17. The quantization apparatus of claim 16, wherein
the addition of the offset level is performed in a direction in which a scale is increased by a set multiple starting from a level corresponding to the lowest value.

18. The quantization apparatus of claim 13, wherein
the processor is further configured to perform the following operation:
when the result of the reference level learning or the result of the offset level learning satisfies the predetermined value and there is no variable parameter that is updated during learning among the parameters, determining a quantization bit based on the reference level set so far and the offset level added so far.

19. The quantization apparatus of claim 13, wherein
when performing the determining of a quantization bit,
the processor is specifically configured to perform the following operation:
determining a quantization bit of parameters corresponding to the reference levels set so far according to a number of reference levels set so far; and
determining a quantization bit of parameters corresponding to the offset levels added so far according to a number of offset levels added so far.

20. The quantization apparatus of claim 18, wherein
before the determining of a quantization bit,
the processor is further configured to perform the following operation:
setting remaining parameters to 0 except for parameters corresponding to the reference levels set so far and parameters corresponding to the offset levels added so far.
